(19) United States
(12) Patent Application Publication
(10) Pub. No.: US 2016/0063769 A1
(43) Pub. Date: Mar. 3, 2016

(54) METHOD AND ARRANGEMENT FOR GENERATING FRANKING IMPRINT DATA FOR A MAIL ITEM

(71) Applicant: Kai Nicolai, Berlin (DE)

(72) Inventor: Kai Nicolai, Berlin (DE)

(21) Appl. No.: 14/838,646

(22) Filed: Aug. 28, 2015

(30) Foreign Application Priority Data
Aug. 29, 2014 (EP) 14182872.3

(51) Int. Cl. G07B 17/00

(52) U.S. Cl. CPC G07B 17/00508; G07B 2017/00612; G07B 2017/00596

(57) ABSTRACT

A method of processing a batch of mail items to be shipped includes the generation of imprint data for a plurality of imprints each to be printed on a mail item of the batch of mail items, the imprint data including third party imprint data. In an online marketplace portal providing step, an online marketplace portal is provided for reaching an agreement on the third party imprint data between a franking system user operating a franking system, in particular a franking machine, for generating the plurality of imprint and a print service requesting party specifying the third party imprint data In a third party imprint data specification step, the print service requesting party specifies the third party imprint data via the online marketplace portal. In a franking batch specification step, the franking system user provides batch information on the batch of mail items via the online marketplace portal. In an agreement step, via the online marketplace portal, an agreement is reached between the print service requesting party and the franking system user on the inclusion of the third party imprint data into the imprint data. Finally, in a batch processing step, the batch of mail items is processed through the franking system, wherein each mail item of the batch of mail items is provided with an imprint as a function of the imprint data including the third party imprint data.

### BACKGROUND OF THE INVENTION

1. Field of the Invention

The present invention relates to a method of processing a batch of mail items to be shipped, the method including the generation of imprint data for a plurality of imprints each to be printed on a mail item of the batch of mail items, the imprint data including third party imprint data. It furthermore relates to a corresponding data processing system configured to process a batch of mail items to be shipped.

2. Description of the Prior Art

In the context of presently used postal transport systems it is known, for example, from DE 10 2004 044 206 A1 (Klausing; the entire disclosure of which is incorporated herein by reference) and EP 1 022 687 A2 (Heiden et al.; the entire disclosure of which is incorporated herein by reference), to print third party imprint data, such as third party advertisements etc., on individual mail items (such as letters, packages, parcels etc.) of a user of a franking system to be shipped via a carrier (such as a postal authority or a privately owned carrier service).

In these known systems, an advertiser (i.e. a third party interested in having its adverts printed on mail items to be shipped) provides the advert data to be printed on such mail items to a data center of a service provider. The user of a franking system intending to ship an individual mail item contacts the data center and, provided that the mail item to be franked and shipped fulfils certain requirements or restrictions set by the advertiser (such as e.g. certain mail item types, recipient address areas, shipping date windows etc.) obtains the third party imprint data together with franking data representing a certain discount (eventually even up to 100%) for the shipping fee to be paid for the shipment of the mail item. The difference between the discounted value charged to the franking system user and the actual shipping fee requested by the carrier is charged to the advertiser and paid by the latter through suitable channels.

These known systems, while allowing the user of the franking system as well as the advertiser to take advantage of the possibilities of modern franking systems, have the disadvantage that they are fairly time consuming, since the user of the franking system has to establish contact to the data center for each item to be franked to obtain the respective franking data and the discount, respectively. In addition, with each contact a comparatively large volume of data has to be transferred to the franking system representing the franking data for each individual mail item.

Furthermore, from the point of view of the advertiser, the system is insofar dissatisfying as he is eventually even forced to purchase a certain shipping fee discount contingent (as it is done e.g. according to DE 10 2004 044 206 A1) without knowing if the contingent will be used at all and, if it is used, to what extent and within which time period it will be used. This renders precise advertisement planning, in particular budget planning, rather complicated or even virtually unfeasible.

### SUMMARY OF THE INVENTION

It is an object of the present invention is to provide a method and a system for processing a batch of mail items to be shipped that, at least to a certain extent overcome the above disadvantages, and which, in particular, allow faster and less resource consuming processing of the mail items, while providing increased flexibility and easier planning to both, the franking system user and the third party requesting the printing service.

The present invention is based on the consideration that faster and less resource consuming processing of the mail items is possible, while providing increased flexibility and easier planning to both, the franking system user and the third party requesting the printing service, if an agreement is reached on an entire batch of mail items to be shipped prior to transmitting the third party imprint data to the franking system. By this means, several advantages are achieved.

First, the overall volume of data to be transmitted to the franking system for such a batch of mail items is greatly reduced, since the corresponding data do not have to be re-transmitted for every individual mail item but, typically, only need to be transmitted once for the entire batch of mail items. This is particularly the case if there is no modification in the third party imprint data over the entire batch of mail items. Hence, the overall volume of data to be transmitted is reduced to a fraction (typically one N-th of the data volume of the known conventional systems, with N being the number of mail items in the batch).

Even in cases where the third party imprint data vary over the batch of mail items, the overall volume of data to be transmitted to the franking system may be considerably reduced, since it may be sufficient to transmit a corresponding item of modification data (in particular, comprising a modification rule) to the franking system, as a function of which the franking system itself may then carry out the modification of the third party imprint data, eventually without the necessity of a further contact to a remote processing unit (such as the online marketplace server).

Second, this agreement on the entire batch of mail items, in a simple manner, provides greatly increased planning security to the franking system user and the third party requesting the printing service. They may immediately agree on the overall conditions of the printing service, such as, in particular, the type and addressees of the mail items and/or the time window within which the mail items of the batch will have to be shipped and/or the discount for the franking system user etc.

Furthermore, flexibility of the system is greatly increased, since the agreement does not necessarily depend on an initial action of the third party requesting the printing service. Rather, as such an initial action, a franking system user may offer such a printing service for a defined batch of mail items over such an online marketplace, such that a third party in need of such a printing service may simply check and accept the printing service offer for this defined batch.

Hence, according to a first aspect of the present invention, there is provided a method of processing a batch of mail items to be shipped, the method including the generation of imprint data for a plurality of imprints each to be printed on a mail item of the batch of mail items, the imprint data including third party imprint data. In an online marketplace portal providing step, an online marketplace portal is provided for reaching an agreement on the third party imprint data between a franking system user operating a franking system, in particular a franking machine, for generating the plurality of imprints and a print service requesting party specifying the third party imprint data. In a third party imprint data specification step, the print service requesting party specifies the third party imprint data via the online marketplace portal. In a franking batch specification step, the franking system user provides batch information on the batch of mail items via the online marketplace portal. In an agreement step, via the online marketplace portal, an agreement is reached between the print service requesting party and the franking system user on the inclusion of the third party imprint data into the imprint data. Furthermore, in a batch processing step, the batch of mail items is processed through the franking system, wherein each mail item of the batch of mail items is provided with an imprint as a function of the imprint data including the third party imprint data.

It will be appreciated that the online marketplace portal may be provided in any suitable and generally known way providing access to interested parties, such as franking system users and print service requesting parties. Techniques for providing such online marketplace portals, e.g. via suitable server units accessible via suitable data networks, are well known in the art and, hence, will not be described here in greater detail.

It will be appreciated that general access to such an online marketplace portal may be restricted to previously registered parties to provide trust between these parties by suitable security mechanisms beforehand. However, with other variants of the invention, such security mechanisms (such as mutual authentication or the like via suitable means, typically involving cryptographic means, such as, for example, the use and verification of digital signatures or digital certificates) may also be implemented during a later stage, e.g. during the agreement step.

It will be further appreciated that the third party imprint data specification step may include any desired specifications of the print service requesting party relating to the contents and/or execution of the processing of the batch of mail items. Preferably, the third party imprint data specification step comprises a third party restriction specification step, the third party restriction specification step comprising specification of at least one third party restriction regarding the processing of the batch of mail items. The third party restriction may include (alone or in arbitrary combinations) one of the restrictions as outlined in the following.

For example, the at least one third party restriction may comprise a specification of an accepted recipient address information for recipients of mail items from the batch of mail items. By this means, the print service requesting party may define the intended or desired address area for recipients of the mail items. This is particularly useful for advertising purposes, for example, where only specific recipients located in a specific recipient address area are considered susceptible to the specific advert.

Furthermore, the at least one third party restriction may comprise a specification of an accepted recipient information for recipients of mail items from of the batch of mail items. By this means, the print service requesting party may define the intended or desired recipients of the mail items. This is again particularly useful for advertising purposes, for example, where only specific recipients are considered susceptible to the specific advert.

Furthermore, the at least one third party restriction may comprise a specification of an accepted mail item type information relating to at least one accepted mail item type for mail items from of the batch of mail items. By this means, the print service requesting party may define the intended or desired mail items to be printed on. This may be particularly useful, for example, where the third party information to be printed makes particular sense in the context of specific mail items (e.g. an advert for a service offered by the third party in the context of mail items of the specific mail item type).

Furthermore, the at least one third party restriction may comprise a specification of an accepted number of mail items, in particular an accepted range of mail items, in the batch of mail items. By this means a maximum and/or minimum number of mail items to receive a representation of the third party imprint data may be specified. This may be particularly useful in the context of a remuneration of the franking system user calculated on the basis of the number of items of the batch (e.g. calculated per item) to clearly define the financial boundaries of the agreement.

Furthermore, the at least one third party restriction may comprise a specification of an accepted remuneration for execution of the batch processing step, in particular an accepted remuneration each mail item of the batch of mail items. This may again be particularly useful to clearly define the financial boundaries of the agreement.

Furthermore, the at least one third party restriction may comprise a specification of an accepted time, in particular an accepted time window, for execution of the batch processing step. By this means, the print service requesting party may define the intended or desired time or period, within which the mail items of the batch are to be printed on and shipped. This may be particularly useful in the context of time critical third party information to be printed, that makes particular sense only within in the specific period (e.g. an advert for a specific event or the like).

Furthermore, the at least one third party restriction may comprise a specification of a singularity information relating to the singularity of the third party imprint data for each mail item of the batch of mail items. By this means the print service requesting party may define that each item of third party information to be printed on one of the mail items of the batch may be singular or unique, respectively (i.e. the third party imprint data are different for each mail item of the batch). This may be particularly useful in the context of individualized third party information to be printed, that requires a difference to the other items of third party information printed on the other items of the batch (e.g. in an advert including lot for a lottery or the like as such an individual and unique item of third party information).

Hence, preferably, the singularity information may also contain a specification or rule on how the singularity or uniqueness of the individual items of third party imprint data is to be achieved. In the simplest case, the singularity information specifies a serial number range for a serial number to be included into each item of third party information represented by the third party imprint data.

Furthermore, the at least one third party restriction may comprise a specification of an exclusivity information relating to the exclusion of further third party imprint data in the imprint data. This provides the beneficial opportunity to exclude the situation that the third party imprint data are printed together with other third party imprint data on the same mail item. This may be useful, for example, in avoiding the printing of adverts of competitors on the same mail item.

Furthermore, the at least one third party restriction may comprise a specification of a representation information relating to the graphic representation of the third party imprint data within the imprint. By this means a clear definition of the desired or required representation of the third party imprint data may be given in a very simple manner (such as e.g. font, font size etc.).

Furthermore, the at least one third party restriction may comprise a specification of a location information relating to the location of the third party imprint data within the imprint. By this means a clear definition of the desired or required location of the representation of the third party imprint data on the mail item may be given in a very simple manner.

It will be appreciated that, similarly, the franking batch specification step may include any desired specifications of the franking system user relating to the contents of the third party imprint data and/or restrictions relating to the third party imprint data and/or the execution of the processing of the batch of mail items.

Preferably, the franking batch specification step comprises a franking system user restriction specification step, the franking system user restriction specification step comprising specification of at least one franking system user restriction regarding the processing of the batch of mail items. The franking system user may include (alone or in arbitrary combinations) one of the restrictions as outlined in the following.

For example, the at least one franking system user restriction may comprise a specification of an intended recipient address information for recipients of mail items from the batch of mail items. By this means, the franking system user may define the intended address area for recipients of the mail items. This is particularly useful for advertising purposes, for example, where only specific recipients located in a specific recipient address area are considered susceptible to the specific advert.

Furthermore, the at least one franking system user restriction may comprise a specification of an intended recipient information for recipients of mail items from of the batch of mail items. By this means, the franking system user may define the intended recipients of the mail items. This is again particularly useful for advertising purposes, for example, where only specific recipients are considered susceptible to the specific advert.

Furthermore, the at least one franking system user restriction may comprise a specification of an intended mail item type information relating to at least one intended mail item type for mail items from of the batch of mail items. By this means, the franking system user may define the intended mail items to be printed on. This may be particularly useful, for example, where the third party information to be printed makes particular sense in the context of specific mail items (e.g. an advert for a service offered by the third party in the context of mail items of the specific mail item type).

Furthermore, the at least one franking system user restriction may comprise a specification of an intended number of mail items, in particular an intended range of mail items, in the batch of mail items. By this means, again, a maximum and/or minimum number of mail items to receive a representation of the third party imprint data may be specified. This may be particularly useful in the context of a remuneration of the franking system user calculated on the basis of the number of items of the batch (e.g. calculated per item) to clearly define the financial boundaries of the agreement.

Furthermore, the at least one franking system user restriction may comprise a specification of an expected remuneration for execution of the batch processing step, in particular an expected remuneration each mail item of the batch of mail items. This may again be particularly useful to clearly define the financial boundaries of the agreement.

Furthermore, the at least one franking system user restriction may comprise a specification of an intended time, in particular an intended time window, for execution of the batch processing step. By this means, the franking system user may define the intended time or period, within which the mail items of the batch are to be printed on and shipped. This may again be particularly useful in the context of time critical third party information to be printed, that makes particular sense only within in the specific period (e.g. an advert for a specific event or the like).

Furthermore, the at least one franking system user restriction may comprise a specification of an exclusivity information relating to the exclusion of third party imprint data in the imprint data. This may be particularly useful, where the representation of certain contents or the information from certain third parties is undesired (such as an advert from a competitor or information of inappropriate content) and, hence, excluded by the franking system user.

Furthermore, the at least one franking system user restriction may comprises a specification of a representation information relating to the graphic representation of the third party imprint data within the imprint. By this means the franking system user may also provide a clear definition of the desired or required representation of the third party imprint data in a very simple manner (such as e.g. font, font size etc.).

Furthermore, the at least one franking system user restriction may comprise a specification of an location information relating to the location of the third party imprint data within the imprint. By this means the franking system user may also provide a clear definition of the desired or required location of the representation of the third party imprint data on the mail item in a very simple manner.

It will be appreciated that any desired chronology may be provided for the third party imprint data specification step and the franking batch specification step, such that, both, the franking system user and the print service requesting party may initiate the agreement. It will be appreciated that both variants may be implemented concurrently in the same system, thereby providing maximum flexibility.

With certain variants of the invention, the third party imprint data specification step may be executed prior to the franking batch specification step (i.e. the agreement is then initiated by the print service requesting party). In this case, preferably, the franking system user may be provided, in a franking system user notification step, with a notification of the execution of the third party imprint data specification step. By this means, delays in reaching the agreement in the agreement step may be largely avoided in a beneficial manner.

It will be appreciated that the notification may ensue in any desired manner, preferably at least partially by electronic means (such as email, text messages in a mobile phone network etc.). Preferably, the notification is executed immediately via a corresponding notification tool of the online marketplace portal. Such notification tools are well known in the art and, hence, will not be described here in further detail.

Preferably, the franking system user notification step is executed as a result of a registration of the franking system user for the franking system user notification step. This registration may have ensued by any suitable means. Preferably, the registration has been previously executed via the online marketplace portal.

With certain variants of the invention, the franking batch specification step may also be executed prior to the third party imprint data specification step (i.e. the agreement is then initiated by the franking system user). In this case, preferably, the print service requesting party is provided, in a print service requesting party notification step, with a notification of the execution of the franking batch specification step. By this means, here as well, delays in reaching the agreement in the agreement step may be largely avoided in a beneficial manner. Again, as outlined above, the notification may ensue in any desired manner, preferably at least partially by electronic means (such as email, text messages in a mobile phone network etc.). Preferably, the notification is executed immediately via a corresponding notification tool of the online marketplace portal.

Preferably, the print service requesting party notification step is again executed as a result of a registration of the print service requesting party for the print service requesting party notification step. This registration may again have ensued by any suitable means. Preferably, the registration has again been previously executed via the online marketplace portal.

It will be appreciated that the agreement between the parties may be reached in any desired and suitable way. This may ensue at least partially in an offline process, which then requires specific input of at least one of the parties via the online marketplace portal to conclude the agreement and continue the process.

Preferably, in the agreement step, the agreement is reached at least partially automatically as a function of at least one agreement criterion previously specified by the print service requesting party and/or the franking system user. It will be appreciated that one or more arbitrary agreement criteria may be defined used. If the specifications set by the franking system user and the print service requesting party set in the preceding franking batch specification step and the preceding third party imprint data specification step sufficiently match, i.e. the one or more arbitrary agreement criteria are sufficiently met, conclusion of the agreement may by automatically assumed. By this means a very simple and rapid process is achieved.

In case there is a mismatch between the specifications of the franking system user and the print service requesting party, i.e. in case the one or more arbitrary agreement criteria are not sufficiently met, there may ensue a (further) notification step issuing a corresponding notification to one or both parties. As a result of this notification, the respective party may modify its specifications in order to come to the agreement or reject the agreement.

Preferably, in an agreement notification step of the agreement step, after the agreement is reached, an agreement notification is provided to the print service requesting party and/or the franking system user including information on the agreement. Again, as outlined above, this notification may ensue in any desired manner, preferably at least partially by electronic means (such as email, text messages in a mobile phone network etc.). Preferably, the notification is executed immediately via a corresponding notification tool of the online marketplace portal.

Again, preferably, the agreement notification step, is executed as a result of a registration of the print service requesting party and/or the franking system user for the agreement notification step, the registration having been previously executed, in particular via the online marketplace portal.

Preferably, the agreement notification comprises an agreement message authenticated by the print service requesting party and/or the franking system user. By this means either party may be assured of the (legally binding) conclusion of the agreement in a very simple manner. To this end, in particular, the security functionality of the franking system (typically of its security module) may be used in a simple and convenient manner. Authentication of the agreement message may ensue in any desired and suitable way. Preferably, cryptographic means are used to provide such authentication in an automated manner. For example, the agreement message may comprise a digital signature generated by the print service requesting party and/or the franking system user (e.g. generated by the security module of the franking system, typically providing such data security functionality). Similar mechanisms may, of course, also be implemented at the service requesting party's side.

It will be appreciated that suitable security mechanisms may be implemented to exclude misuse of the present system. Preferably, in a content verification step prior to the batch processing step, the franking system user and/or an operator of the online marketplace portal verifies a content of the third party imprint data for compliance with at least one content verification criterion, and the batch processing step is only executed if the content of the third party imprint data complies with the at least one content verification criterion. By this means, it may be guaranteed that only authorized and suitable content is printed on the mail items. It will be further appreciated that this verification may ensue automatically, at any desired location, e.g. either at the online marketplace portal, the franking system or any other suitable data processing device remote from the online marketplace portal server and/or the franking system.

It will be further appreciated that the at least one content verification criterion may have been set by any desired party or authority. Preferably, the at least one content verification criterion has been previously established by the franking system user and/or a carrier of the mail item and/or superordinate authority, in particular a governmental authority.

It will be appreciated that remuneration of the franking system user for executing the printing service may ensue by any desired and suitable means at any desired any suitable point in time or upon fulfillment of one or more remuneration criteria of any desired type. Preferably, in a remuneration step after providing at least one of the mail items of the batch of mail items with its imprint, a certain (agreed upon) remuneration is provided from the print service requesting party to the franking system user.

With certain embodiments, the remuneration is provided after a defined plurality, in particular all, of the mail items of the batch of mail items is provided with its respective imprint (representing fulfilment of a quantitative remuneration criterion in the sense of the present invention).

The remuneration may be provided by any suitable means. Preferably, the remuneration is provided in the form of a credit to an account of the franking system user or in the form of a credit to a register of the franking system. In addition or as an alternative, the remuneration may be provided in the form of a credit in a virtual currency (such as e.g. so called bitcoin) to an account of the franking system user.

In addition or as an alternative, the remuneration may be provided only if the imprint includes a postage value that exceeds a predefinable postage value threshold, the postage value threshold, in particular, corresponding to a postage value necessary for shipping the mail item and/or exceeding the remuneration for the mail item. By this means misuse of the system (e.g. through a franking system user applying lower, even zero, postage to the item and actually not shipping the mail items) may be avoided.

In addition or as an alternative, the remuneration may only be provided if a carrier of the mail item provides a carrier receipt information confirming receipt of the mail item by the carrier. By this means misuse of the system may be effectively avoided. Preferably, the carrier receipt information comprises an item of authentication information derived from the third party imprint data and the remuneration is only executed after successful verification of the item of authentication information.

Any desired and suitable item of authentication information may be used. Preferably, the item of authentication information has been generated by a security module of the franking system, thereby allowing very simple implementation of this authentication system. Preferably, the item of authentication information has been generated using cryptographic means, the item of authentication information, in particular, comprising a digital signature of a security module of the franking system. By this means particularly simple and efficient use is made of the security functionality typically available in such franking systems (in particular in typical franking machines).

With certain preferred embodiments, the remuneration is provided if an addressee of the mail item provides an addressee receipt information confirming receipt of the mail item by the addressee. Preferably, the addressee receipt information comprises an item of authentication information derived from the third party imprint data and the remuneration is only executed after successful verification of the item of authentication information.

Again, any desired and suitable item of authentication information may be used. Preferably, the item of authentication information again has been generated by a security module of the franking system. Preferably, the item of authentication information has been generated using cryptographic means, the item of authentication information, in particular, comprising a digital signature of a security module of the franking system. Here as well particularly simple and efficient use is made of the security functionality typically available in such franking systems (in particular in typical franking machines).

It will be appreciated that any of the receipt information as outlined above may be provided by any suitable means, preferably at least partially by electronic means (such as email, text messages in a mobile phone network etc.). Preferably, the notification is executed immediately via a corresponding notification tool of the online marketplace portal.

With certain preferred embodiments of the invention, in an addressee receipt confirmation step, an addressee of the mail item provides an addressee receipt information confirming receipt of the mail item by the addressee. This may ensue in manner similar to the one as outlined above. Preferably, the addressee, in an addressee remuneration step is provided with an addressee remuneration after providing the addressee receipt information. By this means a very simple and efficient incentive may be provided to the recipient of the mail piece to actually confirm receipt of the present mail item.

Such a confirmation of receipt of the mail item by the addressee is beneficial in many ways. First, the franking system user may be assured that his mail item has actually been received. Similar applies for the print service requesting party, such as an advertiser, receiving a confirmation that his third party imprint data (or information, respectively) has reached the intended recipient.

Preferably, the addressee provides the addressee receipt information to the print service requesting party and/or the franking system user. This may be done by any suitable means, preferably at least partially by electronic means (such as email, text messages in a mobile phone network etc.). Preferably, the addressee provides the addressee receipt information immediately via a corresponding notification tool of the online marketplace portal. The addressee may provide the addressee receipt information, for example, via an email system, in particular a secure and trusted email system (such as the so called DeMail system as implemented in Germany).

Preferably, the imprint data, in particular the third party imprint data, comprise addressee feedback information, the addressee retrieves the addressee feedback information from the imprint and the addressee provides the addressee receipt information using the addressee feedback information. By this means, in a very simple yet secure manner, trusted and authentic feedback information may be provided.

Preferably, the imprint comprises an item of addressee feedback information in the form of a machine readable item, in particular in the form of a barcode, the addressee automatically retrieves the addressee feedback information from the machine readable item using a reading device, in particular a smartphone (e.g. a barcode reading application of the smartphone), and the addressee, preferably immediately via the reading device, automatically provides the addressee receipt information. To this end, the addressee feedback information preferably comprises a link to an addressee feedback page of the online marketplace portal. By this means in a very simple yet secure manner, trusted and authentic feedback information may be provided.

With certain preferred embodiments, the addressee receipt information comprises an item of authentication information derived from the third party imprint data and/or an item of authentication information associated to the addressee and the addressee remuneration is only executed after successful verification of the item of authentication information. By this means misuse of the system may be avoided. Preferably, the item of authentication information has been generated by a security module of the franking system and/or a security module of the addressee. Preferably, the item of authentication information has been generated using cryptographic means, the item of authentication information, in particular, comprising a digital signature of a security module of the franking system and/or a security module of the addressee. Here as well particularly simple and efficient use is made of the security functionality typically available in such security module, in particular in such franking systems (in particular in typical franking machines).

With certain preferred embodiments of the invention, in the batch processing step, the franking system generates an individual imprint on each mail item of the batch of mail items, wherein each of the individual imprints preferably comprises unique imprint data generated as a function of the third party imprint data, in particular derived from the third party imprint data, and being unique among the mail items of the batch of mail items. As mentioned above, by this means, individualized third party information (such as e.g. a lot for a lottery) may be printed on each mail item in a very simple and reliable manner.

Preferably, each of the individual imprints comprises unique imprint data derived from the third party imprint data and being generated by a security module of the franking system. Preferably, each of the individual imprints comprises unique imprint data derived from the third party imprint data and being generated, in particular by the franking system, using cryptographic means. Preferably, each of the individual imprints comprises unique imprint data derived from the third party imprint data and comprising a digital signature of a security module of the franking system. By any of this means, again, particularly simple and efficient use is made of the security functionality typically available in such franking systems (in particular in typical franking machines).

The present invention further relates to a data processing system configured to process a batch of mail items to be shipped, including the generation of imprint data for a plurality of imprints to be printed on each mail item of the batch of mail items, the imprint data including third party imprint data. The system comprises a franking system of a franking system user, a print service requesting unit of a print service requesting party, and a server unit. The franking system is configured to generate the plurality of imprints, wherein the franking system in particular comprises a franking machine. The print service requesting unit is configured to specify the third party imprint data, while the server unit is connectable to the franking system and the print service requesting unit via a communication network. The server unit is further configured to provide, in an online marketplace portal providing step, an online marketplace portal for reaching an agreement on the third party imprint data between the franking system user and the print service requesting party. The print service requesting unit is configured to specify, in a third party imprint data specification step, the third party imprint data via the online marketplace portal. The franking system is configured to provide, in in a franking batch specification step, batch information on the batch of mail items via the online marketplace portal. The server unit is further configured to achieve, in an agreement step, via the online marketplace portal, an agreement between the print service requesting party and the franking system user on the inclusion of the third party imprint data into the imprint data. Finally, the franking system is configured to process, in a batch processing step, the batch of mail items, wherein each mail item of the batch of mail items is provided with an imprint as a function of the imprint data including the third party imprint data.

The embodiments and advantages as outlined above in the context of the method according to the invention may be obtained here to the same extent. Hence, in this respect reference is made to the explanations given above.

The present invention further relates to a server unit configured as the server unit of the data processing system according to the invention. The embodiments and advantages as outlined above in the context of the method according to the invention may be obtained to the same extent with such a processing device and such a secure device, respectively. Hence, in this respect reference is made to the explanations given above.

### BRIEF DESCRIPTION OF THE DRAWINGS

FIG. 1 is a block diagram of a preferred embodiment of a data processing system configured to process a batch of mail items according to the invention using which a preferred embodiment of a method of processing a batch of mail items according to the invention may be executed.

FIG. 2A is a first part of a block diagram of a preferred embodiment of a method of processing a batch of mail items according to the invention, which may be executed using the system of FIG. 1.

FIG. 2B is the second part of the block diagram of the method of FIG. 2A.

### DESCRIPTION OF THE PREFERRED EMBODIMENTS

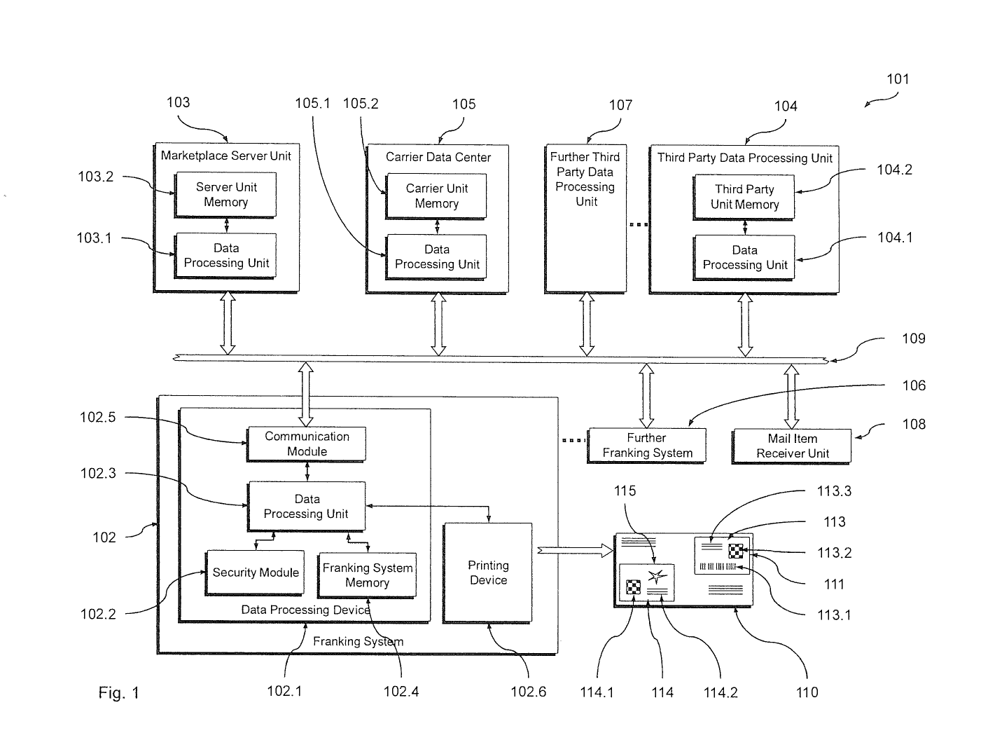

In the following, a preferred embodiment of a data processing system 101 according to the invention adapted to execute a preferred embodiment of the method of processing a batch of mail items will be described in greater detail with reference to FIG. 1.

As can be seen from FIG. 1, the system 101 comprises a franking system 102 (of a franking system user), a remote server 103 for providing an online marketplace portal (of a marketplace service provider), a remote third party data processing unit 104 (of a third party requesting print services), a remote data center 105 (operated by a carrier of the mail items to be processed).

The franking system 102 comprises a data processing device 102.1 with a secure device in the form of a postal security device (PSD) 102.2, a data processing unit 102.3, a franking system memory 102.4 and communication module 102.5, as well as a printing device 102.6 connected to the data processing device 102.1.

In the present embodiment, the franking system is formed by franking machine 102. It will be appreciated however that, with other embodiments of the invention, the franking system 102 may also be formed by any other type of franking system, for example, a so called PC franking system, where certain processing functions are performed by a conventional personal computer (PC) running specific franking software and/or a system comprising a multi-purpose printer for providing the printing functionality.

Furthermore, in the present embodiment, the remote server 103 is a conventional server unit providing an online marketplace portal OMP (of a marketplace service provider) relating to the present invention. The online marketplace portal OMP is provided via a processing unit 103.1 running specific software adapted to execution of the method according to the invention, which is stored in a server memory 103.2.

Furthermore, in the present embodiment, the third party data processing unit 104 is a simple personal computer, where certain processing functions relating to the present invention are performed by a processing unit 104.1 either running specific software adapted to execution of the method according to the invention, which is stored in a third party unit memory 104.2. As an alternative, in a web browser based system, it may be sufficient that the third party data processing unit 104 simply holds conventional web browser software. It will be appreciated, however, that with other embodiments of the invention the third party data processing unit 104 may itself also be a franking system at least similar to the franking system 102.

Furthermore, in the present embodiment, the carrier data center 105 is a conventional remote data center providing functionality relating the present invention via a processing unit 105.1 running specific software adapted to execution of the method according to the invention, which is stored in a carrier data center memory 105.2.

In the present embodiment, the system 101 comprises further units, such as further franking systems 106 (of the same and/or other franking system users) as well as further remote third party data processing units 107 (of the same third party and/or other third parties requesting print services). It will be appreciated that either of the further franking systems 106 may be of any desired type, either identical to the franking system 102 or different therefrom. Similar applies to the further remote third party data processing units 107, either of which may be of any desired type, either identical to the third party data processing unit 104 or different therefrom.

Finally, in the present embodiment, the system 101 comprises at least one, typically a plurality of mail item receiver units 108. The mail item receiver unit 108 may be a simple personal computer, a smartphone or the like, where certain processing functions relating to the present invention are performed by a processing unit either running specific software adapted to execution of the method according to the invention, which is stored in a memory of the mail item receiver unit 108. As an alternative, in a web browser based system, it may be sufficient that the mail item receiver unit 108 simply holds conventional web browser software. It will be appreciated however that, with other embodiments of the invention, the mail item receiver unit 108 may itself also be a franking system at least similar to the franking system 102.

In the present example, at least some, typically all of the units 102 to 108 are located remote from each other. At least some of these units 102 to 108 may establish a mutual connection via a data network 109 (such as, for example, a wide area network as e.g. the Internet, or a telecommunication network).

As mentioned, the franking system 102 may be a conventional franking machine used to generate franking imprints either directly on a mail item 110 (such as a letter or the like) or on a label 111, which is to be associated to a mail item 110 (e.g. to be connected to a parcel or the like).

The postal security device 102.2 may be a physically and/or logically secured data processing unit providing, in a conventional manner, among others, data security functionality to secure certain data, in particular, accounting relevant data, from unauthorized and/or undetected access. To this end, one or more cryptographic functions (including the appliance of one or more cryptographic algorithms as well as one or more cryptographic keys) may be implemented within the postal security device 102.2. It will be appreciated that any further postal security device mentioned in the following may be configured in such a manner.

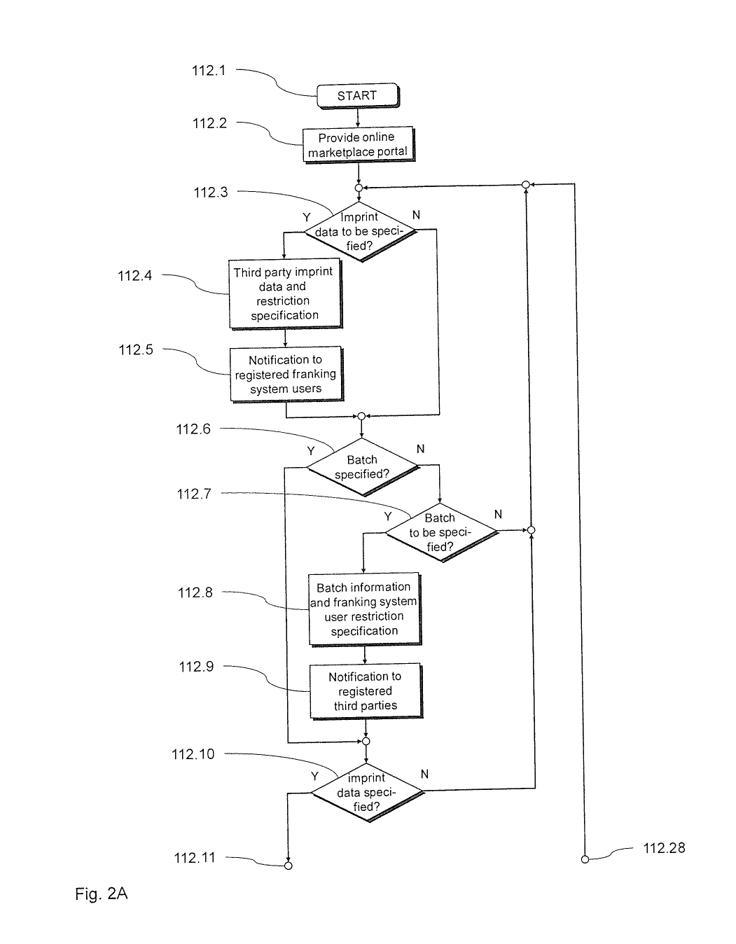

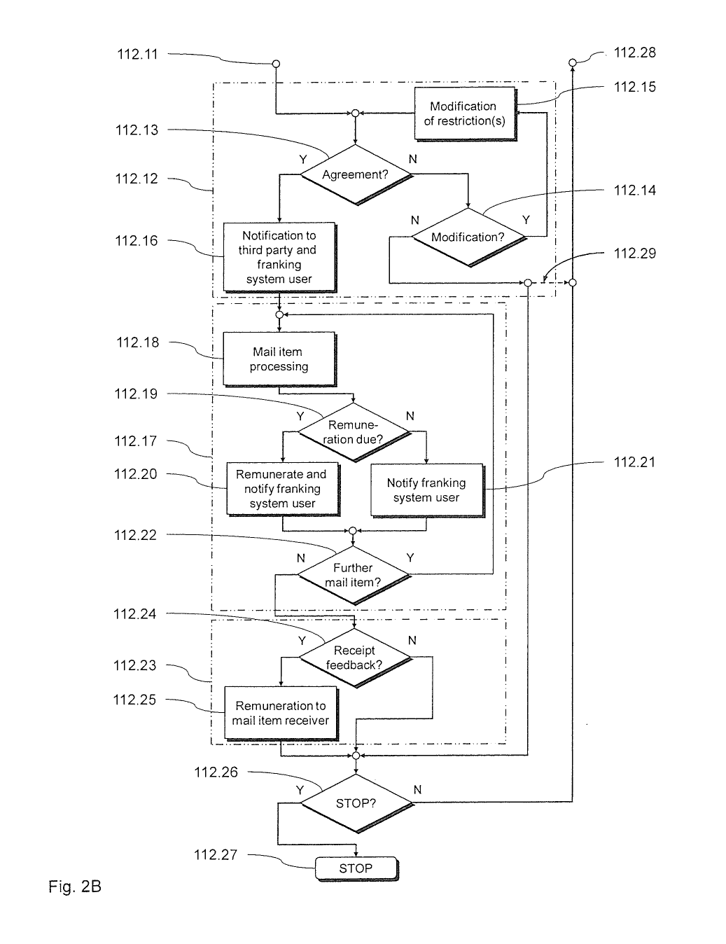

A preferred embodiment of the method of processing a batch of mail items according to the present invention, which is executed using the system 101, will now be described with reference to FIGS. 1 and 2 (composed of FIGS. 2A and 2B).

The method is started in a step 112.1 before, in an online marketplace portal providing step 112.2, an online marketplace portal OMP is provided via the server unit 103. The online marketplace portal OMP is designed for reaching an agreement on third party imprint data TPID between the third party TP (i.e. the user) operating the third party data processing unit 104 and the franking system user FSU operating the franking system 102.

The third party imprint data TPID may represent any information, such as an advertisement, a lot of a lottery etc., which is specified by the third party TP and which the third party TP wishes to distribute to a plurality of (more or less precisely specified) receivers MIR by printing it on a batch of mail items 110 generated by the franking system user FSU operating the franking system 102. Hence, the third party TP, in the sense of the present invention, is a print service requesting party specifying the third party imprint data TPID.

Hence, in a step 112.3, it is checked if a specification of such third party imprint data TPID by any third party TP is to ensue. If this is the case, the print service requesting party TP, in a third party imprint data specification step 112.4, specifies the third party imprint data TPID as well as one or more third party restrictions TPR regarding the processing of the batch of mail items 110. The specification of the third party imprint data TPID and the third party restrictions TPR ensues via an interaction between the third party data processing unit, e.g. unit 104, and the online marketplace portal OMP running on the server unit 103.

It will be appreciated that the third party imprint data specification step 112.4 may include any desired specifications of the print service requesting third party TP relating to the contents and/or execution of the processing of the batch of mail items 110. In the present example, the third party imprint data specification step 112.4, apart from specifying the third party imprint data TPID, i.e. the content to be printed, comprises a third party restriction specification step, during which at least one third party restriction TPR regarding the processing of the batch of mail items 110 is specified by the third party TP.

In the present example, the following third party restrictions TPR may be specified alone or in arbitrary combination by the third party TP via the online marketplace portal OMP.

For example, as a third party restriction TPR, an accepted recipient address information ARAI for recipients of mail items 110 from the batch of mail items may be specified. Hence, the print service requesting party TP may define the intended or desired address area for recipients of the mail items 110. Furthermore, an accepted recipient information ARI for recipients of mail items 110 from of the batch of mail items 110 may be specified. Hence, the print service requesting party may define the intended or desired recipients of the mail items 110. Both is particularly useful for advertising purposes, for example, where only recipients located in a specific recipient address area or even only specific recipients are considered susceptible to the specific content of the third party imprint data TPID, e.g. the advert.

Furthermore, as a third party restriction TPR, an accepted mail item type information MITI relating to at least one accepted mail item type for mail items 110 from of the batch of mail items 110 may be specified. By this means, the print service requesting party TP may define the intended or desired mail items to be printed on. This may be particularly useful, for example, where the content of the third party imprint data TPID, i.e. the third party information TPI to be printed, makes particular sense in the context of specific mail items 110 (e.g. an advert for a service offered by the third party in the context of mail items 110 of the specific mail item type).

Furthermore, as a third party restriction TPR, an accepted number of mail items 110, in particular an accepted range of mail items, in the batch of mail items 110 may be specified by the third party TP. By this means a maximum and/or minimum number of mail items 110 to receive a representation of the third party imprint data TPID may be specified. Furthermore, an accepted remuneration AR for execution of the batch processing, in particular an accepted remuneration for each mail item 110 of the batch of mail items 110 provided with the third party information TPI, may be specified. Both may be particularly useful in the context of a remuneration of the franking system user FSU calculated on the basis of the number of mail items 110 of the batch (e.g. calculated per item 110) to clearly define the financial boundaries of the agreement.

Furthermore, as a third party restriction TPR, an accepted time AT, in particular an accepted time window ATW, for execution of the batch processing may be specified by the third party TP. By this means, the print service requesting third party TP may define the intended or desired time or period, within which the mail items 110 of the batch are to be printed on and shipped. This may be particularly useful in the context of time critical third party information TPI to be printed, that makes particular sense only within in the period or time window ATW as specified (e.g. an advert for a specific event or the like).

Furthermore, as a third party restriction TPR, a singularity information SI relating to the singularity of the third party imprint data TPID or third party information TPI, respectively, for each mail item 110 of the batch of mail items 110. By this means the print service requesting party TP may define that each item of third party information TPI to be printed on one of the mail items 110 of the batch may be singular or unique, respectively (i.e. the third party imprint data TPID are different for each mail item 110 of the batch). This may be particularly useful in the context of individualized third party information TPI to be printed, that requires a difference to the other items of third party information TPI printed on the other mail items 110 of the batch (e.g. in an advert including lot for a lottery or the like as such an individual and unique item of third party information TPI).

In the present example, the singularity information SI may also contain a specification or rule on how the singularity or uniqueness of the individual items of third party imprint data TPID is to be achieved. In the simplest case, the singularity information specifies a serial number range SNR for an individual serial number SN to be included into each item of third party information TPI represented by the third party imprint data TPID. Each individual item of third party imprint data TPID may then, for example, include a different one of these serial numbers SN from the defined serial number range SNR.

Furthermore, as a third party restriction TPR, an exclusivity information EI relating to the exclusion of further third party imprint data FTPID in the imprint data may be specified by the respective third party TP. This provides the beneficial opportunity for the individual requesting third party TP to exclude the situation that its third party imprint data TPID are printed together with other third party imprint data OTPID on the same mail item 110. This may be useful, for example, in avoiding the printing of adverts of competitors on the same mail item 110.

Furthermore, as a third party restriction TPR, the third party TP may specify a representation information RI relating to the graphic representation of the third party imprint data TPID within the imprint on the mail item 110. Similarly, the third party TP may specify a location information LI relating to the location of the representation of the third party imprint data TPID within the imprint. By these means a clear definition of the desired or required representation of the third party imprint data TPID (such as e.g. a prescribed font, font size etc.) and/or a clear definition of the desired or required location of the representation of the third party imprint data TPID on the mail item 110 may be given in a very simple manner.

As soon as the third party imprint data specification step 112.4 has been executed, a franking system user notification step 112.5 is executed. In this franking system user notification step 112.5, one or more franking system users FSU may be provided with a notification of the execution of the third party imprint data specification step 112.4.

In the present example, the notification of the franking system users FSU is executed immediately through an email sent via a corresponding notification software tool NT of the online marketplace portal OMP. Such notification tools are well known in the art and, hence, will not be described here in further detail.

In the present example, the franking system user notification step 112.5 is executed as a result of a previous registration of the respective franking system user FSU for the franking system user notification step 112.5. This registration may have ensued by any suitable means. Preferably, the registration has been previously executed via a corresponding registration software tool of the online marketplace portal OMP. During the registration process, the respective franking system user FSU has entered his email address which will then be used for the notification.

It will be appreciated that it may be provided that the respective franking system user FSU, during registration or at a later point in time, may specify one or more arbitrary conditions for being notified. Hence, by this means it may be achieved that a notification is only sent if these conditions are fulfilled, allowing the franking system user FSU to reduce the number of notifications received. For example, the franking system user FSU may exclude certain third parties TP or content of the third party information TPI.

Hence, if one or more franking system users FSU have previously registered for such a notification, the corresponding numbers of notifications will be sent. Otherwise (i.e. if no franking system user FSU has registered), the notification step 112.5 will be skipped or gone through without issuing any such notification, respectively.

Once the notification step 112.5 is completed, it is checked, in a step 112.6, if a specification of a batch of mail items 110 by any franking system user FSU has already ensued. If this is not the case, it is checked, in a step 112.8, if a specification of a batch of mail items 110 by any franking system user FSU is now to ensue. If this is the case, the respective franking system user FSU, in a franking batch specification step 112.8, specifies the batch information BI on the batch of mail items 110 intended to be processed. The franking system user FSU may also specify as one or more franking system user restrictions FSUR relating to the contents of the third party imprint data TPID and/or restrictions relating to the third party imprint data TPID and/or the execution of the processing of the batch of mail items 110. The specification of the batch information BI and the franking system user restrictions FSUR ensues via an interaction between the franking system, e.g. franking system 102, and the online marketplace portal OMP running on the server unit 103.

It will be appreciated that, similar to the options available for the requesting third party TP, the franking batch specification step 112.8 may include any desired specifications of the franking system user FSU relating to the contents and/or execution of the processing of the batch of mail items 110. In the present example, the franking batch specification step 112.8, apart from specifying the batch information BI, such as the number of mail items 110 of the batch, comprises a franking system user restriction specification step, during which at least one franking system user restriction FSUR regarding the processing of the batch of mail items 110 is specified by franking system user FSU.

In the present example, the following franking system user restriction FSUR may be specified alone or in arbitrary combination by the franking system user FSU via the online marketplace portal OMP.

In the present example, an intended recipient address information IRAI for recipients of mail items 110 from the batch of mail items 110 may be specified. Furthermore, an intended recipient IRI information for recipients of mail items 110 from of the batch may be specified. By this means, the franking system user FSU may define the intended address area for recipients of the mail items 110 and/or even the intended recipients of the mail items 110. Both may be particularly useful for advertising purposes, for example, where only specific recipients or recipients located in a specific recipient address area are considered susceptible to the specific third party information TPI (e.g. an advert).

Furthermore, in the present example, an intended mail item type information IMITI relating to at least one intended mail item type MIT for mail items 110 of the batch may be specified. By this means, the franking system user FSU may define the intended mail items 110 to be printed on. This may be particularly useful, for example, where the third party information TPI to be printed makes particular sense in the context of specific mail items 110 (e.g. an advert for a service offered by the third party TP in the context of mail items 110 of the specific mail item type MIT).

Furthermore, in the present example, an intended number IN of mail items 110, in particular an intended range IR of mail items 110, in the batch of mail items 110 may be specified. By this means, again, a maximum and/or minimum number of mail items 110 to receive a representation of the third party imprint data TPID may be specified. This may be particularly useful in the context of a remuneration of the franking system user FSU calculated on the basis of the number of mail items 110 of the batch (e.g. calculated per mail item 110) to clearly define the financial boundaries of the agreement.

Furthermore, in the present example, the franking system user FSU may specify an expected remuneration ER for execution of the batch processing, in particular an expected remuneration ER for each mail item 110 of the batch. This may again be particularly useful to clearly define the financial boundaries of the agreement.

Furthermore, in the present example, the franking system user FSU may specify an intended time IT, in particular an intended time window ITW, for processing the batch of mail items 110. By this means, the franking system user FSU may define the intended time window ITW or period, within which the mail items 110 of the batch are to be printed on and shipped. This may again be particularly useful in the context of time critical third party information TPI to be printed, that makes particular sense only within in the specific period or time window ITW, respectively (e.g. an advert for a specific event or the like).

Furthermore, in the present example, an exclusivity information EI relating to the exclusion of third party imprint data TPID in the imprint data may be specified. This may be particularly useful, where the representation of certain content or the information from certain third parties TP is undesired (such as an advert from a competitor or information of inappropriate content) and, hence, excluded by the franking system user FSU.

Furthermore, in the present example, a representation information RI relating to the graphic representation of the third party imprint data TPID within the imprint may be specified. By this means the franking system user FSU may also provide a clear definition of the desired or required representation of the third party imprint data TPID in a very simple manner (such as e.g. font, font size etc.).

Finally, in the present example, the franking system user may specify a location information LI relating to the location of the third party imprint data TPID within the imprint. By this means the franking system user FSU may also provide a clear definition of the desired or required location of the representation of the third party imprint data TPID on the mail item 110.

As soon as the batch specification step 112.8 has been executed, a print service requesting party notification step 112.9 is executed. In this print service requesting party notification step 112.9, one or more print service requesting parties TP may be provided with a notification of the execution of the batch specification step 112.8.

In the present example, the notification of the print service requesting parties TP is executed immediately through an email sent via the notification software tool NT of the online marketplace portal OMP.

In the present example, the print service requesting party notification step 112.9 is executed as a result of a previous registration of the respective print service requesting party TP for the print service requesting party notification step 112.9. This registration, again, may have ensued by any suitable means. Preferably, the registration has been previously executed via the registration software tool of the online marketplace portal OMP. During the registration process, the respective print service requesting party TP has entered its email address which will then be used for the notification.

It will be appreciated that it may be provided that the respective print service requesting party TP, during registration or at a later point in time, may also specify one or more arbitrary conditions for being notified. Hence, by this means it may be achieved that a notification is only sent if these conditions are fulfilled, allowing the print service requesting party TP to reduce the number of notifications received.

Basically, any of the third party restrictions TPR specified by the print service requesting party TP in the third party restriction specification step of step 112.4 may be used as such a notification condition. Similar may apply also to the notification conditions defined by the franking system user FSU, which may also correspond to the franking system user restrictions FSUR defined by the franking system user FSU in the franking system user restriction specification step of step 112.8.

Hence, if one or more print service requesting parties TP have previously registered for such a notification, the corresponding numbers of notifications will be sent. Otherwise (i.e. if no print service requesting party TP has registered), the notification step 112.9 will be skipped or gone through without issuing any such notification, respectively.

It will be appreciated that, in the present example, also a different chronology may be provided for the third party imprint data specification step 112.4 and the franking batch specification step 112.8. In other words, it may also be the case that the franking batch specification step 112.8 is executed prior to the third party imprint data specification step 112.4. Hence, both, the franking system user FSU and the print service requesting party TP may initiate the agreement.

To this end, in the present example, if it is determined in step 112.3 that no third party imprint data TPID are to be specified, the method jumps to step 112.6 and, if it is determined that no batch has yet been specified, jumps to step 112.7. If it is determined in step 112.7 that a batch is to be specified, the franking batch specification step 112.8 ensues in this case then prior to a third party imprint data specification step 112.4.

In any case, once a franking batch has been specified, it is checked, in a step 112.10, if third party imprint data TPID have been specified. If this is not the case, the method jumps back to step 112.3, otherwise, it continues via linking point 112.11 (see FIGS. 2A and 2B) to an agreement step 112.12.

In the agreement step 112.12, via the online marketplace portal OMP, an agreement AGR is reached between the print service requesting party TP and the franking system user FSU on the inclusion of the third party imprint data TPID into the imprint data for the mail items 110.

It will be appreciated that the agreement between the print service requesting third party TP and the franking system user FSU may be reached in any desired and suitable way. This may ensue at least partially in an offline process, which then requires specific input of at least one of the parties TP, FSU, typically via the online marketplace portal OMP, to conclude the agreement AGR and to continue the process.

In the present example, in the agreement step 112.12, the agreement AGR is reached at least partially automatically as a function of at least one agreement criterion AGRC previously specified by the print service requesting party TP and/or the franking system user FSU. It will be appreciated that one or more arbitrary agreement criteria may be defined and used.

In the present example, in a step 112.13, it is checked if the specifications or restrictions set by the franking system user FSU and the print service requesting party TP in the preceding franking batch specification step 112.8 and the preceding third party imprint data specification step 112.4, respectively, sufficiently match (i.e. if the franking system user restrictions FSUR and the third party restrictions TPR sufficiently match). If this is the case, i.e. if one or more arbitrary defined agreement criteria AGRC are sufficiently met, conclusion of the agreement AGR may is automatically assumed in step 112.13. By this means a very simple and rapid process is achieved.

It will be appreciated that individual priorities (selected from two or more priority levels) may be assigned to the respective restrictions FSUR, TPR and it may be provided, for example, as one of said agreement criteria AGRC that a match in one restriction pair (having a higher priority level) overrides a mismatch in another restriction pair (having a lower priority level). Hence, in this case, the agreement AGR may even be reached automatically in case of such a partial mismatch.

Subsequently, in an agreement notification step 112.15 of the agreement step 112.12, after the agreement AGR is reached, an agreement notification AGRN is provided to the print service requesting party TP and/or the franking system user FSU including information on the agreement AGR. Again, this agreement notification AGRN may ensue in any desired manner, preferably at least partially by electronic means (such as email, text messages in a mobile phone network etc.). Preferably, the agreement notification AGRN is executed immediately via the notification tool NT of the online marketplace portal OMP.

Again, the agreement notification step 112.14 is executed as a result of a registration of the print service requesting party TP and/or the franking system user FSU for the agreement notification step 112.14, the registration having been previously executed, in particular via the online marketplace portal OMP.

In the present example, the agreement notification AGRN comprises an agreement message AGRM authenticated by the print service requesting party TP and the franking system user FSU to have both parties assured of the legally binding conclusion of the agreement AGR.

To this end, prior to sending the agreement notification AGRN, the marketplace server unit 103 transmits a corresponding agreement information AGRI to the security module 102.2 of the franking system 102. The franking system 102 verifies this agreement information AGRI and (if verification was positive) generates a first digital signature SIG1(AGRI) over at least part of the agreement information AGRI and returns the agreement information AGRI together with the first digital signature SIG1(AGRI) to the marketplace server unit 103.

Similarly, prior to sending the agreement notification AGRN, the marketplace server unit 103 transmits the agreement information AGRI to the third party data processing unit 104. The third party data processing unit 104 then verifies this agreement information AGRI and (if verification was positive) generates a second digital signature SIG2(AGRI) over at least part of the agreement information AGRI and returns the agreement information AGRI together with the second digital signature SIG2(AGRI) to the marketplace server unit 103.

The marketplace server unit 103 then uses the agreement information AGRI, the first digital signature SIG1(AGRI) and the second digital signature SIG1(AGRI) to generate the agreement notification AGRN.

It will be appreciated that, with other embodiments of the invention, any other cryptographic means may be used to provide such authentication in an automated manner. Furthermore, in addition or as an alternative, the marketplace server unit 103 may provide such authentication of the agreement notification AGRN (alone or in arbitrary combination with the authentication of the franking system user FSU and/or the requesting third party TP).

In case it is found, in step 112.13, that there is a mismatch between the franking system user restrictions FSUR and the third party restrictions TPR, i.e. in case the one or more agreement criteria AGRC are not sufficiently met, there may ensue a (further) notification step issuing a corresponding mismatch notification MISN to one or both parties FSU, TP. As a result of this notification, the respective party FSU, TP may modify its specifications or restrictions FSUR, TPR in order to come to the agreement AGR or reject the agreement AGR.

Hence, in the present example, in a step 112.15, it is checked if a modification is to be made to one or more of the franking system user restrictions FSUR and the third party restrictions TPR. If this is the case, in a restriction modification step 112.16, the corresponding modification is made to the corresponding franking system user restriction FSUR or the third party restriction TPR, respectively. Subsequently, step 112.13 is repeated.

It will be appreciated that, in the restriction modification step 112.16, arbitrary modifications may be made to the franking system user restrictions FSUR and/or the third party restrictions TPR (preferably via the online marketplace portal OMP). The modifications may be made either manually (i.e. by a corresponding input of the respective party TP or FSU) or at least partially automatically as a function of one or more previously set restriction modification rules RMR. These restriction modification rules RMR may have been set in order to enable automatic modification of the restrictions FSUR and/or TPR and, ultimately, agreement. The restriction modification rules RMR may either have been previously set by the operator of the online marketplace portal OMP or by either of the parties TP and FSU.

It will be appreciated that arbitrarily sophisticated restriction modification rules RMR may be applied at the online marketplace portal OMP. In particular, arbitrary conditions may be defined for the modification of one or more restrictions FSUR and/or TPR as a function of the match (or mismatch) in one or more different restriction pairs (FSUR, TPR). Furthermore, restriction modification priorities RMP (selected from two or more priority levels) may be set, which define the sequence in which the restrictions FSUR and/or TPR are to be modified (i.e. what restriction is modified first, next, last etc.).

It will be appreciated that suitable security mechanisms may be implemented to exclude misuse of the present system. Hence, in the present example, in a content verification step of step 112.13 (i.e. prior to any processing of the batch of mail items 110), the franking system user FSU and/or the operator of the marketplace server 103 verifies a content of the third party imprint data TPID for compliance with at least one content verification criterion CVC, and the agreement AGR is only reached (and, ultimately, the batch of mail items 110 is only processed using the TPID), if the content of the third party imprint data TPID complies with the at least one content verification criterion CVC.

By this means, it may be guaranteed that only authorized and suitable content is printed on the mail items 110. As mentioned, this verification may ensue automatically, at any desired location, e.g. either at the online marketplace server 103, the franking system 102 or any other suitable data processing device remote from the online marketplace server 103 and/or the franking system 102. Furthermore, this verification may ensue any time before the actual mail item 110 is to be printed on.

It will be further appreciated that the at least one content verification criterion CVC may have been set by any desired party or authority. In the present example, the at least one content verification criterion CVC has been previously established by the franking system user FSU. It will be appreciated however that, with other embodiments of the invention, a carrier of the mail items 110 and/or a superordinate authority, in particular a governmental authority, may have set the at least one content verification criterion CVC.

After the parties FSU and TP have been notified of the agreement in step 112.14, the batch processing step 112.17 follows. In a mail item processing step 112.18 of the batch processing step 112.17, a mail item 110 is processed via the franking system 102.

More precisely, in the present example, via the printer 102.6 of the franking system 102, a franking imprint or indicium 113 is printed on the label 111 that is applied (or to be applied) to the mail item 110. The indicium 113 may be any conventional indicium, typically containing a one-dimensional barcode 113.1 (typically containing tracking or value added service information), a two-dimensional barcode 113.2 (typically containing security relevant information, such as evidence of postage payment information, and other postal information) as well as clear text and/or graphics 113.3.

Similarly, the printer 102.6 of the franking system 102 (or another printer connected to the franking system 102), generates a second imprint 114 either on a label 115 that is to be applied to the mail item 110 or immediately on the mail item 110. The second imprint 114 is a representation of the third party imprint data TPID which are the basis of the agreement AGR concluded in the agreement step 112.12 and which have been transferred to the franking system 102 (e.g. together with the agreement notification AGRN).

Printing of the second imprint 114 is executed as a function of the third party restrictions TPR specified in the third party imprint data specification step 112.4 and eventually modified and agreed upon in the agreement step 112.12 as explained above. Hence, in the present example, the second imprint 114 is generated respecting the agreed upon accepted recipient address information ARAI and the accepted recipient information ARI (i.e. only for specific recipients and/or recipient address areas), the accepted mail item type information MITI (i.e. only on specific mail items), the accepted number of mail items 110 in the batch, the accepted remuneration AR (i.e. at a specific price), the accepted time AT or accepted time window ATW for execution of the batch processing (i.e. within a specific period), the singularity information SI (i.e. with content individual to each item, such as a lot for a lottery etc.), the exclusivity information EI (i.e. under the exclusion of other third party imprint data), the representation information RI (i.e. in a specific representation), and the location information LI (i.e. at a specific location on the mail item 110), respectively.

For example, as a function of the singularity information SI, the franking system 102 generates an individual imprint 113 on each mail item 110, wherein each of the individual imprints 113 comprises unique imprint data UID in the form of a lot number LN of a lottery, which are derived from the third party imprint data TPID and which are unique among the mail items 110 of the batch of mail items 110.

Moreover, for each of the individual imprints 113 the security module 102.2 derives the unique imprint data UID from the third party imprint data TPID agreed upon. More precisely, the unique imprint data UID of each of the individual imprints 113 comprise a unique information UI derived from the third party imprint data TPID and a digital signature SIG(UI) of the security module 102.2 over this unique information UI. By this means, again, particularly simple authentication of the unique imprint data UID is provided and efficient use is made of the security functionality typically available in such a franking system 102.

It will be appreciated that, in the present example, the franking system 102 is adapted to prevent printing of the second imprint 114 in case the accepted time AT or accepted time window ATW for execution of the batch processing has not yet started or has expired. Hence, it is guaranteed that the corresponding third party restriction TPR is respected. Typically, a corresponding notification will be issued to the franking system user FSU (e.g. via the franking system 102).

The second imprint 114 may comprise any type of representation of the third party imprint data TPID, such as (alone or in arbitrary combination) barcodes 114.1 (one-dimensional and/or two-dimensional) clear text and graphics 114.2, as it is shown in FIG. 1. In particular, the representation of the unique imprint data UID, in particular, the lot number LN, may be in clear text and/or in machine readable form (e.g. in a barcode).

In the present example, once a mail item 110 has been provided with imprints 113 and 114, it is checked, in a step 112.19, if remuneration FREM for the generation of the second imprint 114 is to be provided to the franking system user FSU according to the terms of the agreement AGR concluded in step 112.12. This might be the case after each print on a mail item if the agreement AGR provides such remuneration FREM immediately after printing each second imprint 114. Hence, in case it is determined in step 112.18 that remuneration FREM is due, the latter will be provided, in a remuneration step 112.20, to the amount and in the way agreed upon in the agreement AGR.

The remuneration FREM to the franking system user FSU may be provided by any suitable means. For example, the remuneration FREM may be provided in the form of a credit to an account (e.g. a bank account) of the franking system user FSU. With other embodiments of the invention, the remuneration FREM may be provided in the form of a credit to a register of the franking system 102, such as e.g. a postage value register of the security module 102.2 (in a manner as it is generally known for such postage registers, such that it will not be explained herein in greater detail). In addition or as an alternative, the remuneration FREM may be provided in the form of a credit in a virtual currency (such as e.g. so called bitcoin) to an account of the franking system user FSU.

Furthermore, in step 112.20, the franking system user FSU may be notified (by suitable means, e.g. via the franking system 102) of the remaining time for processing the batch and/or the remaining number of mail items to be processed in the batch according to the agreement AGR.

It will be appreciated however that, with other types of the agreement AGR, remuneration FREM of the franking system user FSU for executing the printing service may ensue at any other suitable point in time or upon fulfillment of one or more remuneration criteria RC of any desired type.

For example, with certain types of the agreement AGR, the remuneration FREM is provided after a defined fraction of the mail items 110 (typically all of the mail items 110 of the batch) has provided with its respective second imprint 114. Such a condition for remuneration, in other words, represents a quantitative remuneration criterion RC in the sense of the present invention. In such a case, for example, it may be determined in step 112.19 that the remuneration is not yet due (since the required number of mail items 110 hasn't yet been provided with the second imprint 114).

Hence, in a notification step 112.21, the franking system user FSU may be notified (by suitable means, e.g. via the franking system 102) about the fact that remuneration FREM is not yet due. He may also be notified of the remaining time for processing the batch and/or the remaining number of mail items to be processed in the batch according to the agreement AGR as well as the requirements for obtaining remuneration FREM.

Subsequently, it is checked, in a step 112.22, if a further mail item 110 is to be processed. If this is the case, the method jumps back to step 112.18, otherwise it continues to step 112.23.

It will be appreciated that, with certain types of the agreement AGR, the remuneration FREM to the franking system user FSU may be provided only if the indicium 113 includes a postage value PV that exceeds a predefinable postage value threshold PVT. The postage value threshold PVT may, for example, correspond to a postage value PV necessary for shipping the mail item 103. Furthermore, typically, the postage value threshold PVT exceeds the remuneration FREM for processing the mail item 110. By this means misuse of the system (e.g. through a franking system user applying lower, even zero, postage to the mail item 110 and actually not shipping the mail items 110) may be avoided.

Furthermore, with certain types of the agreement AGR, the remuneration FREM to the franking system user FSU may only be provided if a carrier of the mail item 110 provides a carrier receipt information CRECI confirming receipt of the mail item 110 by the carrier MIC of the mail items. By this means misuse of the system may be effectively avoided. Preferably, the carrier receipt information CRECI is provided by the carrier data center 105 to the marketplace server 103, which then triggers appropriate remuneration.

Furthermore, the carrier receipt information CRECI may comprise an item of authentication information IAI derived from the third party imprint data TPID that are retrieved by the carrier MIC from the mail item 110. The remuneration is then only executed after successful verification of the item of authentication information IAI (e.g. at the marketplace server 103 or any other instance responsible for this function).

It will be appreciated that any desired and suitable item of authentication information IAI may be used. Preferably, the item of authentication information IAI has been generated by the security module 102.2 of the franking system 102, thereby allowing very simple implementation of this authentication system. Typically, the item of authentication information IAI has been generated using cryptographic means. Preferably, the item of authentication information IAI comprises a digital signature SIG(TPID) of the security module 102.2 over at least part of the third party imprint data TPID. By this means particularly simple and efficient use is made of the security functionality typically available in such a franking system 102.

Furthermore, with certain types of the agreement AGR, the remuneration FREM to the franking system user FSU is only provided if an addressee of the mail item 110 provides an addressee receipt information ARECI confirming receipt of the mail item 110 by the addressee. Preferably, the addressee receipt information ARECI again comprises an item of authentication information IAI derived from the third party imprint data TPID, and the remuneration to the franking system user FSU is only executed after successful verification of the item of authentication information IAI. Again, any desired and suitable item of authentication information IAI may be used. Preferably, the item of authentication information IAI again has been generated as described above (i.e. including a digital signature SIG(TPID) of the security module 102.2 over at least part of the third party imprint data TPID).

It will be appreciated that any of the receipt information CRECI, ARECI as outlined above may be provided by any suitable means, preferably at least partially by electronic means (such as email, text messages in a mobile phone network etc.). Preferably, the notification is executed immediately via the corresponding notification tool NT of the online marketplace portal OMP.

In the present example, in an addressee receipt confirmation step 112.23, it is checked, in a step 112.24, if an addressee of the mail item 110 has provided the addressee receipt information ARECI (confirming receipt of the mail item 110 by the addressee) in the manner as outlined above.

If this is the case, in the present example, the addressee, in an addressee remuneration step 112.25 is provided with an addressee remuneration AREM after providing the addressee receipt information. By this means a very simple and efficient incentive may be provided to the recipient of the mail piece 110 to actually confirm receipt of the present mail item 110. Such a confirmation of receipt of the mail item 110 by the addressee is beneficial in many ways. First, the franking system user FSU may be assured that his mail item 110 has actually been received. Similar applies for the print service requesting party TP, such as an advertiser, receiving a confirmation that his third party imprint data TPID (or third party information TPI, respectively) has reached the intended recipient.

Preferably, the addressee provides the addressee receipt information ARECI to the print service requesting party TP and/or the franking system user FSU. This may be done by any suitable means, preferably at least partially by electronic means (such as email, text messages in a mobile phone network etc.). Preferably, the addressee provides the addressee receipt information ARECI immediately via the corresponding notification tool NT of the online marketplace portal OMP. The addressee may provide the addressee receipt information ARECI, for example, via an email system, in particular a secure and trusted email system (such as the so called DeMail system as implemented in Germany).

Preferably, the imprint data on the mail item 110, in particular the third party imprint data TPID, comprise addressee feedback information AFI, which the addressee retrieves from the imprints 113, 114. Then the addressee provides the addressee receipt information ARECI using the addressee feedback information AFI. By this means, in a very simple yet secure manner, trusted and authentic feedback information may be provided.

Preferably, the imprint 113, 114 comprises an item of addressee feedback information IAFI in the form of a machine readable item, for example, in the form of the barcode 114.1. The addressee then automatically retrieves the addressee feedback information AFI from the barcode 114.1 using a suitable reading device of a mail item receiver unit 108. This may be accomplished in a very simple way, for example, via a smartphone 108 (e.g. a barcode reading application of the smartphone 108). The addressee, preferably immediately via the reading device 108, automatically provides the addressee receipt information ARECI to the intended recipient. To this end, the addressee feedback information ARECI preferably comprises a link to an addressee feedback page of the online marketplace portal OMP or an email address for contacting the online marketplace portal OMP. By this means in a very simple yet secure manner, trusted and authentic feedback information may be provided.

With certain preferred embodiments, the addressee receipt information ARECI comprises an item of authentication information IAI derived from the third party imprint data TPID (as it has been explained above) and/or an item of authentication information IAI associated to the addressee and the addressee remuneration AREM is only executed after successful verification of the item of authentication information IAI. By this means misuse of the system may be avoided. Preferably, the item of authentication information IAI has been generated by the security module 102.2 of the franking system 102 and/or a security module of the smartphone 108 (i.e. the mail item receiver unit) of the addressee. Again, preferably, the item of authentication information has been generated using cryptographic means, the item of authentication information, in particular, comprising a digital signature SIG of the security module 102.2 and/or a digital signature SIG security module of the smartphone 108 (i.e. the mail item receiver unit) of the addressee.

In a step 112.26 it is then checked if the method is to be stopped. If this is the case, the method stops in a step 112.27, otherwise it jumps back to step 112.3 (via linking point 112.28).

Similar applies if it is determined, in step 112.15, that no (further) modification is to be made to the restrictions FSUR and TPR to achieve an agreement AGR, i.e. in the case that an agreement has failed to be reached. As indicated by the dashed contour 112.29 in FIG. 2B, it may however also be provided that, in this case (i.e. in case of no agreement being reached), the method immediately jumps back to step 112.3.

It will be appreciated that the online marketplace portal OMP may be provided in any suitable and generally known way providing access to interested parties, such as franking system users FSU and print service requesting parties TP. Techniques for providing such online marketplace portals, e.g. via suitable server units 103 accessible via suitable data networks 109, are well known in the art and, hence, will not be described here in greater detail.

It will be appreciated that general access to such an online marketplace portal OMP may be restricted to previously registered parties FSU, TP to provide trust between these parties FSU, TP by suitable security mechanisms beforehand. However, with other variants of the invention, such security mechanisms (such as mutual authentication or the like via suitable means, typically involving cryptographic means, such as, for example, the use and verification of digital signatures or digital certificates) may also be implemented during a later stage, e.g. during the agreement step 112.12.

It should be noted that, in certain cases communication between the participants in the system 101 doesn't have to happen in exclusively electronic way. For example, a communication channel at least partially established by regular mail or telephone between the participants in the system 101 may also be used. Furthermore, any other communication means from a communication device other than the data processing devices shown may be used, such as e-mail, for example. However, any of the communication channels used may also be a purely electronic channel formed by a communications link between the respective data processing system components.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method of processing a batch of mail items to be shipped, said method including the generation of imprint data for a plurality of imprints each to be printed on a mail item of said batch of mail items, said imprint data including third party imprint data, said method comprising:
in an online marketplace portal providing step, an online marketplace portal is provided for reaching an agreement on said third party imprint data between a franking system user operating a franking system for generating said plurality of imprint and a print service requesting party specifying said third party imprint data;
in a third party imprint data specification step, said print service requesting party specifies said third party imprint data via said online marketplace portal;
in a franking batch specification step, said franking system user provides batch information on said batch of mail items via said online marketplace portal;
in an agreement step, via said online marketplace portal, an agreement is reached between said print service requesting party and said franking system user on the inclusion of said third party imprint data into said imprint data; and
in a batch processing step, said batch of mail items is processed through said franking system, so that each mail item of said batch of mail items is provided with an imprint as a function of said imprint data including said third party imprint data.

2. The method according to claim 1, wherein
said third party imprint data specification step comprises a third party restriction specification step;
said third party restriction specification step comprising specification of at least one third party restriction regarding the processing of said batch of mail items;
and wherein
said at least one third party restriction, in particular, comprises a specification of an accepted recipient address information for recipients of mail items (110) from said batch of mail items.

3. The method according to claim 2 wherein said at least one third party restriction comprises a specification of an accepted recipient information for recipients of mail items from of said batch of mail items.

4. The method according to claim 2 wherein said at least one third party restriction comprises a specification of an accepted mail item type information relating to at least one accepted mail item type for mail items from of said batch of mail items.

5. The method according to claim 2 wherein said at least one third party restriction comprises a specification of an accepted number of mail items, in particular an accepted range of mail items, in said batch of mail items.

6. The method according to claim 2 wherein said at least one third party restriction comprises a specification of an accepted remuneration for execution of said batch processing step, in particular an accepted remuneration each mail item of said batch of mail items.

7. The method according to claim 2 wherein said at least one third party restriction comprises a specification of an accepted time, in particular an accepted time window, for execution of said batch processing step.

8. The method according to claim 2 wherein said at least one third party restriction comprises a specification of a singularity information relating to the singularity of said third party imprint data for each mail item of said batch of mail items.

9. The method according to claim 2 wherein said at least one third party restriction comprises a specification of an exclusivity information relating to the exclusion of further third party imprint data in said imprint data.

10. The method according to claim 2 wherein said at least one third party restriction comprises a specification of a representation information relating to the graphic representation of said third party imprint data within said imprint.

11. The method according to claim 2 wherein said at least one third party restriction comprises a specification of an location information relating to the location of said third party imprint data within said imprint.

12. The method according to claim 2 wherein said franking batch specification step comprises a franking system user restriction specification step;
said franking system user restriction specification step comprising specification of at least one franking system user restriction regarding the processing of said batch of mail items;
and wherein
said at least one franking system user restriction comprises a specification of an intended recipient address information for recipients of mail items from said batch of mail items.

13. The method according to claim 12 wherein said at least one franking system user restriction comprises a specification of an intended recipient information for recipients of mail items from of said batch of mail items.

14. The method according to claim 12 said at least one franking system user restriction comprises a specification of an intended mail item type information relating to at least one intended mail item type for mail items from of said batch of mail items.

15. The method according to claim 12 said at least one franking system user restriction comprises a specification of an intended number of mail items in a range of mail items, in said batch of mail items.

16. The method according to claim 12 said at least one franking system user restriction comprises a specification of an expected remuneration for execution of said batch processing step, in particular an expected remuneration for each mail item of said batch of mail items.

17. The method according to claim 12 said at least one franking system user restriction comprises a specification of an intended time, in particular an intended time window, for execution of said batch processing step.

18. The method according to claim 12 said at least one franking system user restriction comprises a specification of an exclusivity information relating to the exclusion of third party imprint data in said imprint data.

19. The method according to claim 12 said at least one franking system user restriction comprises a specification of a representation information relating to the graphic representation of said third party imprint data within said imprint.

20. The method according to claim 12 said at least one franking system user restriction comprises a specification of an location information relating to the location of said third party imprint data within said imprint (114).

21. The method according to claim 1 wherein said third party imprint data specification step is executed prior to said franking batch specification step;
and wherein
said franking system user is provided, in a franking system user notification step, with a notification of said execution of said third party imprint data specification step;
said notification is executed via said online marketplace portal;
said franking system user notification step being executed as a result of a registration of said franking system user for the franking system user notification step, said registration having been previously executed, in particular via said online marketplace portal.

22. The method according to claim 1, wherein
said franking batch specification step is executed prior to said third party imprint data specification step;
and wherein
said print service requesting party is provided, in a print service requesting party notification step, with a notification of said execution of said franking batch specification step;
said notification is executed via said online marketplace portal,
said print service requesting party notification step, in particular, being executed as a result of a registration of said print service requesting party for said print service requesting party notification step, said registration having been previously executed, in particular via said online marketplace portal.

23. The method according to claim 1, wherein
in said agreement step, said agreement is reached at least partially automatically as a function of at least one agreement criterion previously specified by said print service requesting party and/or said franking system user; and,
in an agreement notification step of said agreement step, after said agreement is reached, in particular, an agreement notification is provided to said print service requesting party and/or said franking system user including information on the agreement;
and wherein
said agreement notification, in particular, is executed via said online marketplace portal;
said agreement notification step, in particular, being executed as a result of a registration of said print service requesting party and/or said franking system user for said agreement notification step, said registration having been previously executed, in particular via said online marketplace portal;
said agreement notification comprises an agreement message authenticated by said print service requesting party.

24. A method as claimed in claim 23 wherein said franking system user comprising a digital signature generated by said print service requesting party and/or said franking system user.

25. The method according to claim 1, wherein,
in a content verification step prior to said batch processing step, said franking system user and/or an operator of said online marketplace portal verifies a content of said third party imprint data for compliance with at least one content verification criterion; and
said batch processing step is only executed if said content of said third party imprint data complies with said at least one content verification criterion;
and wherein,
said at least one content verification criterion has been previously established by at least one of said franking system user or a carrier of said mail item or superordinate authority.

26. The method according to claim 1, wherein,
in a remuneration step after providing at least one of said mail items of said batch of mail items with its imprint, a remuneration is provided from said print service requesting party to said franking system user,
and wherein
said remuneration is executed after a defined plurality of said mail items of said batch of mail items is provided with its imprint;
said remuneration is provided in the form of a credit to an account of said franking system user or in the form of a credit to a register of said franking system.

27. The method according to claim 26 wherein said remuneration is provided in the form of a credit in a virtual currency to an account of said franking system user.

28. The method according to claim 26 wherein said remuneration is provided if said imprint includes a postage value that exceeds a predefinable postage value threshold, said postage value threshold corresponding to a postage value necessary for shipping said mail item, or exceeds said remuneration for said mail item.

29. The method according to claim 26 wherein said remuneration is provided if a carrier of said mail item provides a carrier receipt information confirming receipt of said mail item by said carrier, said carrier receipt information, in particular, comprising an item of authentication information derived from said third party imprint data and said remuneration only being executed after successful verification of said item of authentication information, said item of authentication information, in particular, having been generated by a security module of said franking system, said item of authentication information, in particular, having been generated using cryptographic means, said item of authentication information, in particular, comprising a digital signature of a security module of said franking system.

30. The method according to claim 26 wherein said remuneration, in particular, is provided if an addressee of said mail item provides an addressee receipt information confirming receipt of said mail item by said addressee, said addressee receipt information, in particular, comprising an item of authentication information derived from said third party imprint data and said remuneration only being executed after successful verification of said item of authentication information, said item of authentication information, in particular, having been generated by a security module of said franking system, said item of authentication information, in particular, having been generated using cryptographic means, said item of authentication information, in particular, comprising a digital signature of a security module of said franking system (102).

31. The method according to claim 1, wherein,
in an addressee receipt confirmation step, an addressee of said mail item provides an addressee receipt information confirming receipt of said mail item by said addressee;
and wherein,
said addressee, in an addressee remuneration step is provided with an addressee remuneration after providing said addressee receipt information.

32. The method according to claim 31 wherein said addressee provides said addressee receipt information to said print service requesting party and/or said franking system user.

33. The method according to claim 31 wherein said addressee provides said addressee receipt information via said online marketplace portal.

34. The method according to claim 31 wherein said addressee provides said addressee receipt information via an email system, in particular a secure email system.

35. The method according to claim 31 wherein said imprint data said third party imprint data, in particular, comprises addressee feedback information, said addressee retrieves said addressee feedback information from said imprint and said addressee provides said addressee receipt information using said addressee feedback information.

36. The method according to claim 31 wherein said imprint comprises an item of addressee feedback information in the form of a machine readable item, in the form of a barcode (, said addressee automatically retrieves said addressee feedback information from said machine readable item using a reading device, a smartphone, and said addressee, via said reading device, automatically provides said addressee receipt information, said addressee feedback information, comprises a link to an addressee feedback page of said online marketplace portal;

37. The method according to claim 31 wherein said addressee receipt information comprises an item of authentication information derived from said third party imprint data and/or an item of authentication information associated to said addressee and said addressee remuneration only being executed after successful verification of said item of authentication information, said item of authentication information having been generated by a security module of said franking system or a security module of said addressee, said item of authentication information having been generated using cryptographic means, said item of authentication information comprises a digital signature of a security module of at least one of said franking system and a security module of said addressee.

38. The method according to claim 1, wherein,
in said batch processing step, said franking system generates an individual imprint (114) on each mail item of said batch of mail items;
and wherein
each of said individual imprint comprises unique imprint data generated as a function of said third party imprint data, in particular derived from said third party imprint data, and being unique among said mail items of said batch of mail items.

39. The method according to claim 38 wherein each of said individual imprint comprises unique imprint data derived from said third party imprint data and being generated by a security module of said franking system.

40. The method according to claim 38 wherein each of said individual imprint comprises unique imprint data derived from said third party imprint data and being generated, in particular by said franking system, using cryptographic algorithm.

41. The method according to claim 38 wherein each of said individual imprints comprises unique imprint data derived from said third party imprint data and comprising a digital signature of a security module of said franking system.

42. A data processing system configured to process a batch of mail items to be shipped, including the generation of imprint data for a plurality of imprint to be printed on each mail item of said batch of mail items, said imprint data including third party imprint data, said system comprising:
a franking system of a franking system user;
a print service requesting unit of a print service requesting party; and
a server unit;
said franking system being configured to generate said plurality of imprint;
said print service requesting unit being configured to specify said third party imprint data;
said server unit being connectable to said franking system and said print service requesting unit via a communication network;
said server unit being configured to provide, in an online marketplace portal providing step, an online marketplace portal for reaching an agreement on said third party imprint data between said franking system user and said print service requesting party;
said print service requesting unit being configured to specify, in a third party imprint data specification step, said third party imprint data via said online marketplace portal;
said franking system being configured to provide, in in a franking batch specification step, batch information on said batch of mail items via said online marketplace portal;
said server unit being configured to achieve, in an agreement step, via said online marketplace portal, an agreement between said print service requesting party and said franking system user on the inclusion of said third party imprint data into said imprint data; and
said franking system being configured to process, in a batch processing step, said batch of mail items, so that each mail item of said batch of mail items is provided with an imprint as a function of said imprint data including said third party imprint data.

43. The system according to claim 42, wherein
said print service requesting unit is configured to specify, in a third party restriction specification step, at least one third party restriction regarding the processing of said batch of mail items.

44. The system of claim 42, wherein said franking system is configured to specify, in a franking system user restriction specification step, at least one franking system user restriction regarding the processing of said batch of mail items.

45. The system of claim 42, wherein said server unit is configured to provide, in a franking system user notification step, said franking system with a notification of an execution of said third party imprint data specification step.

46. The system of claim 42, wherein said server unit is configured to provide, in a print service requesting party notification step, said print service requesting unit with a notification of an execution of said franking batch specification step.

47. The system according to 42, wherein
said server unit is configured to achieve, in said agreement step, at least partially automatically said agreement as a function of at least one agreement criterion previously specified via said print service requesting unit and/or said franking system, and said server unit is configured to provide, in an agreement notification step of said agreement step, after said agreement is reached, an agreement notification to at least one of said print service requesting unit or said franking system.

48. The system of claim 47, wherein said server unit is configured to provide, in an agreement notification step of said agreement step, after said agreement is reached, an agreement notification to at least one of said print service requesting unit or said franking system, said agreement notification comprising an agreement message authenticated by at least one of said print service requesting party or said franking system user comprising a digital signature generated by at least one of said print service requesting unit or said franking system.

49. The system of claim 47, wherein said franking system is configured to verify, in a content verification step prior to said batch processing step, a content of said third party imprint data for compliance with at least one content verification criterion, and said franking system is configured to execute said batch processing step only if said content of said third party imprint data complies with said at least one content verification criterion.

50. The system of claim 47, wherein said server unit is configured to initiate, in a remuneration step after providing at least one of said mail items of said batch of mail items with its imprint, a remuneration provided from said print service requesting party to said franking system user.

51. The system according to any claim 42 comprising:
an addressee unit connected to said server unit and being configured to provide, in an addressee receipt confirmation step, an addressee receipt information confirming receipt of said mail item by said addressee.

52. The system of claim 51, wherein said franking system is configured to generate, in said batch processing step, an individual imprint on each mail item of said batch of mail items, wherein each of said individual imprint comprises unique imprint data generated as a function of said third party imprint data, in particular derived from said third party imprint data, and being unique among said mail items of said batch of mail items.
